(19) United States
(12) Patent Application Publication
(10) Pub. No.: US 2013/0098042 A1
(43) Pub. Date: Apr. 25, 2013

(54) DETECTION OF THE OVERSPEED OF A FREE TURBINE BY MEASURING USING A TORQUE METER

(71) Applicants: Jean-Luc Charles Gilbert Frealle, Pau (FR); Alain Michel Perbos, Idron (FR)

(72) Inventors: Jean-Luc Charles Gilbert Frealle, Pau (FR); Alain Michel Perbos, Idron (FR)

(73) Assignee: TURBOMECA, Bordes (FR)

(21) Appl. No.: 13/807,110

(22) PCT Filed: Jul. 1, 2011
(86) PCT No.: PCT/FR11/51558

§ 371 Date: Dec. 27, 2012

(30) Foreign Application Priority Data
Jul. 2, 2010 (FR) 1055350

(51) Int. Cl. F02C 9/28

(52) U.S. Cl. CPC F02C 9/28
USPC 60/734

(57) ABSTRACT

An overspeed protection device includes at least one torque measurement unit supported by an output shaft coupled mechanically to a free turbine of a turbine engine and a signal processing unit able to transmit to a turbine engine regulating system a command to reduce a flow of fuel injected if it is detected that the torque has dropped below a first datum value. The signal processing unit is shaped to command a reduction of the flow if it is detected that the torque has dropped below a first datum value, the torque measurement used to trigger the reduction being taken during a rotation corresponding to a fraction of a revolution of the output shaft.

The field of the present invention is that of turbomachines and, more particularly, of safeguarding the free turbines of turbine engines.

Turbine engines are commonly used for the propulsion of aircraft, particularly for the propulsion and lift of helicopters. These engines comprise a gas generator consisting, amongst other things, along a drive shaft, of one or more compressors, of an annular combustion chamber surrounding the shaft and of one or more turbines, referred to as coupled turbines, which drive the compressor or compressors via the drive shaft. The gases leaving this generator are then directed onto a turbine impeller, referred to as a free turbine, which is associated with a power shaft, separate from the drive shaft of the generator, and which supplies the useful power for propulsion and/or lift. All of the components downstream of the combustion chamber, including the chamber and the free turbine, are referred to as the hot parts, the other parts being by contrast considered to be cold.

When designing a turbine engine it is appropriate to give due consideration to the risk of a breakage of the free turbine shaft because, when such an event occurs, the power supplied by the gases to the turbine is no longer absorbed by the equipment driven by this shaft and the rotational speed of the free turbine increases extremely rapidly. Such overspeed very soon causes vanes to break and/or to become detached from the turbine disk. These vanes are thrown violently outward because of centrifugal force and may even pass through the casing surrounding the turbine, causing very significant engine damage, and potentially even endangering the aircraft and its passengers.

Aircraft engine designers are therefore obliged to prevent the consequences of such overspeed. One common way of affording the required protection is to fit around the turbine a retaining ring capable of absorbing the energy of any vanes that become detached and of containing them within the engine. Such a device of course represents a significant mass.

Overspeed detection devices have been evaluated, using one or more sensors to sense the rotational speed of the turbine impeller and a signal processing unit, or any other programmable logic system which, when overspeed starts to occur, acts on the regulation of the gas generator in order to reduce or cut the flow of fuel injected. When applied to an engine that has no retaining ring, this device has to cover breakage of a shaft internal to the engine. The disadvantage is that a sensor has therefore to be positioned in close proximity to the free turbine, namely in a space in which the temperature is particularly high. This is because it is not possible to position the speed sensor on the opposite end of the shaft to the free turbine because it would then not detect shaft breakage if this breakage occurred between the free turbine and the point at which the sensor was positioned. Aside from the fact that problems with installing these sensors in hot spaces are particularly complex, the sensors used experience environmental conditions that are unfavorable for a function where the demand for reliability is very high. Because the operating environment is not favorable to sensor reliability or to sensor life, the problem regarding the availability of the safety function may arise because of the insufficient reliability of the sensors.

Overspeed detection devices that work by measuring the torque applied by the turbine of a turbomachine are known, for example from patent applications U.S. Pat. No. 2,912,822 or U.S. Pat. No. 5,363,317, or even the applicant company's patent application FR 2931552. These devices have the disadvantages of describing either mechanical devices for torque measurement, the reaction times of which, although not specified, are relatively lengthy because of the technology used, or devices that employ speed measurement. They are not well suited to detecting overspeeding of a free turbine, experiencing explosive runaway if the shaft it drives should break, if detection has not been made within an extremely short deadline.

The system for detecting overspeed in the free turbine of a helicopter engine needs, essentially, to cover 3 types of event:

engine runaway such that the engine uncontrollably delivers a power that is in excess of the power required,

breakage, external to the engine, of the coupling of the engine to the helicopter power train,

breakage, internal to the engine, of the coupling between the free turbine and the output shaft. A shaft breakage internal to the engine is to be understood to mean a breakage between the free turbine and the torque meter, and also a breakage of the torque meter shaft itself.

The first two scenarios can generally be handled by directly monitoring the speed of the output shaft. By contrast, the third cannot be handled without installing measurement means in the hot part.

It is an object of the present invention to alleviate these disadvantages by proposing an overspeed prevention device for the free turbine should its shaft break, which does not have some of the disadvantages of the prior art and which allows a very rapid reduction in the flow of fuel injected into the gas generator, when such an incident occurs.

To this end, one subject of the invention is an overspeed protection device for a free turbine of a turbine engine comprising a gas generator comprising at least one compressor, a combustion chamber, at least one coupled turbine and a system for regulating the amount of fuel injected into said combustion chamber, the gases from said generator being directed onto said free turbine, said device comprising at least one torque measurement means supported by an output shaft coupled mechanically to said free turbine and a signal processing unit able to transmit to the turbine engine regulating system a command to reduce the flow of fuel injected if it is detected that the torque has dropped below a first datum value, characterized in that the torque measurement used to trigger said reduction is taken during a rotation corresponding to a fraction of a revolution of said output shaft.

The use of a torque meter device which delivers signals that make it possible simultaneously to determine the speed of the shaft and the torque transmitted and which is characterized by an extremely rapid response time, means that shaft breakage internal to the turbine can be detected almost instantaneously so that the regulating system can intervene before the free turbine has reached a prohibitively high rotational speed. It may be noted that, on this occasion, the torque meter can also be used to measure the shaft speed.

Advantageously, the measurement means is a phonic wheels torque meter, the fraction of a revolution being defined by the sector comprised between two consecutive teeth of said phonic wheel.

In a first embodiment, said torque measurement is updated for each new fraction of a revolution. Information regarding torque dynamics is thus obtained extremely rapidly, and this is suited to the detection of overspeed on the basis of a high engine speed.

Advantageously, the reduction in flow is triggered only if the torque value drops below a first datum value within a first predetermined time interval.

More advantageously still, the first time interval is less than or equal to 5 ms.

For preference, in this first embodiment, said processing unit triggers said reduction in flow only if the measured power is greater than or equal to approximately 50% of the maximum takeoff power.

In a second embodiment, said torque measurement is obtained by a running average over the values recorded during a rotation of said output shaft over at least one revolution. This averaged information, which can be averaged over one revolution or over an integer number of revolutions, is suited to detecting overspeed using an intermediate engine speed.

Advantageously, the reduction in flow is triggered only if the torque value drops below a second datum value in a second predetermined time interval.

More advantageously still, the second time interval is less than or equal to 10 ms.

For preference, said processing unit triggers said reduction in flow in this second embodiment only if the measured power is comprised approximately between 25 and 50% of the maximum takeoff power.

In another embodiment, said processing unit further triggers a reduction in flow if the measured power is less than approximately 25% of the maximum takeoff power and if the instantaneous torque measurement drops below a third datum value, said datum value being dependent on the rotation speed of the gas generator.

Advantageously, the torque measurement means comprises two phonic wheels torque meters with non-interlaced teeth and said processing unit also triggers a reduction in flow if a difference in speed between the two phonic wheels is detected.

The invention also relates to a calculation box containing a signal processing unit or a programmable logic system able to transmit, to the system for regulating a turbine engine equipped with a device as described hereinabove, a command to reduce the flow if it detects that the torque measured on an output shaft has dropped below a datum value. It finally relates to a turbine engine comprising an overspeed protection device for its free turbine as described hereinabove.

The invention will be better understood, and further objects, details, features and advantages thereof will become more clearly apparent, during the course of the detailed explanatory description which follows, of one entirely illustrative and nonlimiting example of how the invention is embodied, given with reference to the attached schematic drawings.

In these drawings:

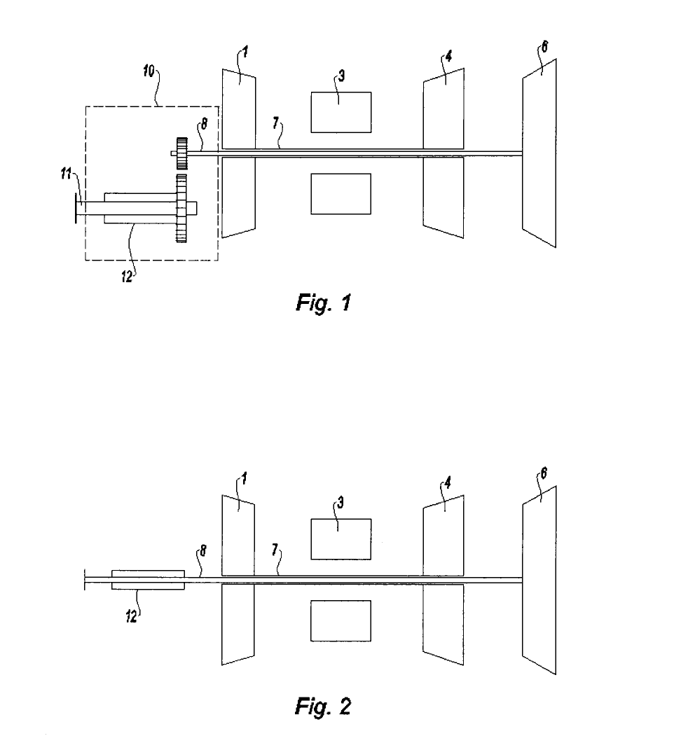

FIG. 1 is a schematic view in cross section of a free-turbine turbine engine, with a reduction gear, fitted with a torque meter according to the invention;

FIG. 2 is a schematic view in cross section of a free-turbine turbine engine, without reduction gear, fitted with a torque meter according to the invention,

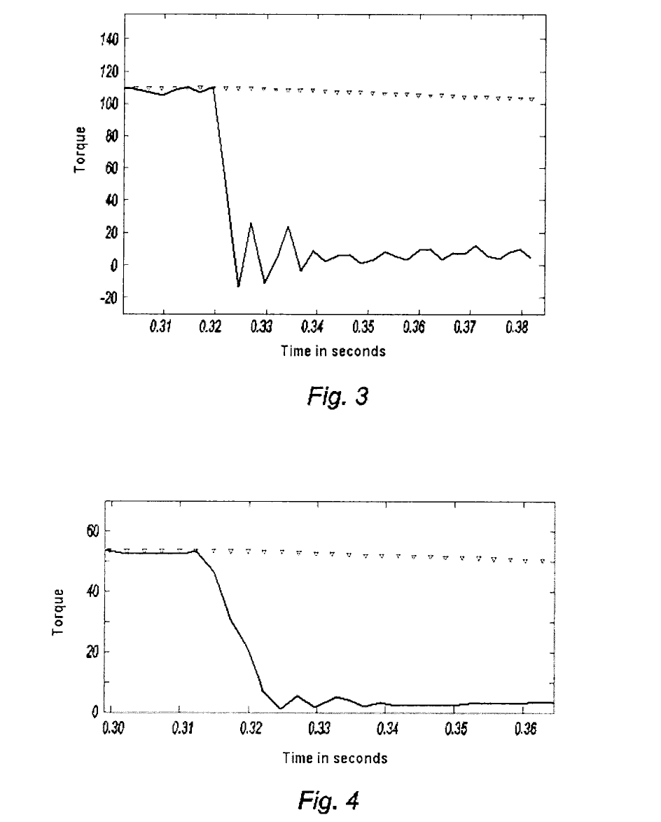

FIG. 3 is a schematic view showing how the torque measured on the output power shaft of the turbine engine evolves as a function of time using a first measurement method according to the invention, when the free turbine shaft breaks, the turbine engine being at high power;

FIG. 4 is a schematic view showing how the torque measured on the power output shaft of the turbine engine evolves as a function of time using a second measurement method according to the invention, when the free turbine shaft breaks, the turbine engine operating at an intermediate power.

Reference is made to FIG. 1 which shows a turbine engine comprising, in the conventional way, a compressor 1, a combustion chamber 3 on which the gases are ejected from into a coupled turbine 4. The coupled turbine is rigidly connected to the compressor via a shaft 7 known as the drive shaft. On the outlet side of the coupled turbine, the gases are directed onto a free turbine 6, on which there is mounted a power shaft 8 which extends toward the upstream side of the turbine engine by passing through the drive shaft 7.

In the example depicted in FIG. 1, the power shaft 8 enters a gearbox where it drives various accessories via dedicated drive shafts and, in the depicted example of a helicopter, via reduction gear module 10 incorporated into the engine, in which there emerges a helicopter power train drive shaft referred to as the output shaft 11.

Mounted on this output shaft 11 is a torque meter 12, depicted schematically in FIG. 1, which constantly measures the magnitude of the torque transmitted by the free turbine 6 to this output shaft 11. It is associated with a signal processing unit mounted in a calculation box (not depicted) and intended to raise the alarm on the basis of the torque measured, if the power shaft 8 should break. This torque meter may be a conventional strain-gauged torque meter or, for preference, a torque meter that works by measuring the phase shift that exists between two phonic wheels positioned one on each side of a torsionally flexible part of the output shaft 11. Such a torque meter may be a torque meter of the type referred to as having interlaced teeth, with just one phonic wheel, or alternatively of the type with noninterlaced teeth, having two phonic wheels positioned at the two ends of a part of the shaft that is capable of undergoing torsional deformation (referred to as the torque meter shaft). As depicted, the torque meter 12 has interlaced teeth and is positioned on the output shaft 11 in the region of the pinion, referred to as the output pinion, via which the power shaft 8 drives the output shaft 11.

FIG. 2 depicts a configuration similar to that of FIG. 1, in which the invention is applied to an engine without reduction gear, with the torque meter mounted directly on the power shaft 8. Elements identical to those of FIG. 1 are assigned the same references and are not described anew.

FIGS. 3 and 4 depict, in solid line, the evolutions, as a function of time, of the torque measured by the torque meter 12 when the power shaft 8 breaks. In FIG. 3, the gas generator is, prior to breakage, at a high power point, close to the maximum takeoff power (MTOP). In FIG. 4, the gas generator is, prior to breakage, at an intermediate power of between 25 and 50% of the maximum power MTOP. The figures also show a curving dotted line that gives the torque values, available in the turbine engine regulating computer. These values are used for the engine operation information supplied to the pilot and for regulating the turbine engine and cannot be used for detecting shaft breakage; the search for precision actually leads to a slower measurement dynamic because of the time taken for integration and filtering. It may be seen that these values do not decrease sufficiently rapidly to be usable for detecting breakage of the power shaft 8.

In FIG. 3, the curve in solid line represents a detailed interpretation of the phase shift measurements taken on the passage of three consecutive teeth on two phonic wheels which, in our example of phonic wheels with 4 teeth each, corresponds to a rotation of the shaft by one quarter of a revolution. It will be noted that measuring across three consecutive teeth is the quickest measurement that can be taken. The fraction of a revolution over which the measurement is taken is defined here by the angular sector between two consecutive teeth of one of the two phonic wheels. In FIG. 4, the curve drawn in solid line this time depicts the detailed interpretation of the measurements taken as a running average over a full revolution of the shaft, the measurement being updated on each quarter of a revolution.

In the example of FIG. 3, it may be noted that the measured torque decreases very suddenly and that its value, measured over a quarter of a revolution, reaches a minimal value after a time of around 5 ms. The measured value then fluctuates around this minimal value, with relaxation of ripple corresponding to the torsional response of the shaft line still secured to the torque meter 12. This value of 5 ms is low enough to be compatible with the response time requirements for a device for safeguarding the engine following a breakage of the power shaft 8. The information is then sent, via the ad hoc processing unit, to the turbine engine regulating system in order to cause it to reduce the quantity of fuel injected sharply. The near-instantaneous reduction in power transmitted to the free turbine prevents the latter from developing pronounced overspeed. Because the maximum rotational speed reached following breakage remains limited, the mechanical integrity of the vanes can be guaranteed through a simple engineering design of their attachments, or, failing that, using a retaining ring of only limited weight.

It may be seen from FIG. 4 that the time taken for the torque measurement to reach its minimal value is around 10 ms. It may also be seen that the level of ripple after the first minimal level has been reached is of a relative amplitude that is markedly smaller than those observed in FIG. 3. The ratio between the amplitude of the ripple measured and the amount by which the torque is reduced to reach its first minimal value following shaft breakage is, in the latter instance, far smaller in comparison with the previous scenario. The detection time is therefore longer, but this is entirely acceptable because it is applied at intermediate powers.

In the light of these observations, the invention defines rules for detecting a shaft breakage, drawing a distinction between turbine engine operation at high power (considered in theory to be greater than 50% of the MTOP, without this value being imperative) and operation at an intermediate value (between 25 and 50% of MTOP).

In the first scenario, the device tasked with detecting breakage monitors the change in torque taking measurements over a minimal fraction of the revolution that will allow a measurement to be extracted. Breakage is declared, when, with the turbine engine still regulated for this high power, the measured torque drops below a predetermined threshold in a given time window. This detection threshold is set, with suitable margins, to a value that is sufficiently distant from the starting value that reliable detection can be obtained and at a value that is sufficiently close in order to avoid disturbances connected with the relaxation ripple effect.

In the intermediate engine speed scenario, the rebound on the torque value that is observed after the first minimal value reached, would lead to too small a difference for it to be possible to define a reliable detection threshold if the same rule and the same torque measurement method were used. For that reason, for operation at intermediate engine speeds, the invention uses a torque value calculated on the basis of the average of the values recorded, using a running measurement over one revolution of the shaft, the measured value being updated for each new fraction of a revolution thus making it possible to obtain new phase shift information. Because in this case the rebound is of smaller magnitude than before, it is possible, as in the previous scenario, to define a detection threshold that guarantees that a breakage has indeed occurred, without raising false alarms.

The consequence of using this method in place of the method used at high powers is that the threshold value is reached later than in the previous scenario (in 10 ms rather than 5). However, because the powers involved in such a scenario are lower, the angular acceleration of the free turbine following breakage is correspondingly lower. The overspeed that ensues is then sufficiently limited that the turbine mechanical integrity remains guaranteed despite this slight delay in detecting the breakage.

It is also possible to set in place monitoring for lower engine speeds (below 25% of MTOP) by establishing, for example, a theoretical law, in theory substantially linear, which gives the minimum torque applied to the output shaft 11, in normal operation, as a function of the rotational speed of the gas generator and then, using this curve, by defining a curve that is offset downward by an acceptable margin so as to form a breakage detection threshold. If the measured torque drops below this threshold then a breakage has occurred and an alarm signal has to be sent to the computer that regulates the gas generator to cause it to reduce the amount of fuel injected.

Such a method would inevitably lead to delays being introduced into the alarm triggering calculation program that were longer than those observed with the methods described for high and intermediate powers. However, once again, because the starting power is low, the overspeed that the free turbine will reach will be very limited and remain compatible with measures otherwise taken for guaranteeing the mechanical integrity thereof.

It is possible, by way of alternative, to replace the torque level thresholds described hereinabove with thresholds on the gradients of decrease in torque from the pre-breakage value.

In one particular embodiment of the invention, the torque meter 12 adopted is a torque meter with two phonic wheels and non-interlaced teeth, each wheel being secured to the end of the torque meter shaft. In this alternative form, detection of breakage of the torque meter shaft itself is afforded by detecting a difference in speed between the two phonic wheels.

Although the invention has been described in conjunction with one particular embodiment, it is quite clear that it encompasses all technical equivalents of the means described and combinations thereof where these fall within the scope of the invention.

1-14. (canceled)

15. An overspeed protection device for a free turbine of a turbine engine comprising a gas generator comprising at least one compressor, a combustion chamber, at least one coupled turbine and a system for regulating the amount of fuel injected into said combustion chamber, the gases from said generator being directed onto said free turbine, said device comprising:
at least one torque measurement means supported by an output shaft coupled mechanically to said free turbine; and
a signal processing unit able to transmit to the turbine engine regulating system a command to reduce the flow of fuel injected if it is detected that the torque has dropped below a first datum value,
wherein the signal processing unit is shaped to command a reduction of the flow if it is detected that the torque has dropped below a first datum value, the torque measurement used to trigger said reduction being taken during a rotation corresponding to a fraction of a revolution of said output shaft.

16. The protection device as claimed in claim 15, in which the measurement means is a phonic wheels torque meter, the fraction of a revolution being defined by the sector comprised between two consecutive teeth of one of the two said phonic wheels.

17. The protection device as claimed in claim 15, in which said torque measurement is updated for each new fraction of a revolution.

18. The protection device as claimed in claim 17, in which the reduction in flow is triggered only if the torque value drops below a first datum value within a first predetermined time interval.

19. The protection device as claimed in claim 18, in which the first time interval is less than or equal to 5 ms.

20. The protection device as claimed in claim 17, in which said processing unit triggers said reduction in flow only if the measured power is greater than or equal to approximately 50% of the maximum takeoff power.

21. The protection device as claimed in claim 15, in which said torque measurement is obtained by a running average over the values recorded during a rotation of said output shaft over at least one revolution.

22. The protection device as claimed in claim 21, in which the reduction in flow is triggered only if the torque value drops below a second datum value in a second predetermined time interval.

23. The protection device as claimed in claim 22, in which the second time interval is less than or equal to 10 ms.

24. The protection device as claimed in claim 21, in which said processing unit triggers a reduction in flow only if the measured power is comprised approximately between 25 and 50% of the maximum takeoff power.

25. The protection device as claimed in claim 21, in which said processing unit further triggers a reduction in flow if a measured power is less than approximately 25% of the maximum takeoff power and if the instantaneous torque measurement drops below a third datum value, said datum value being dependent on the rotation speed of the gas generator.

26. The protection device as claimed in claim 15, in which the torque measurement means comprises a phonic wheels torque meter with non-interlaced teeth and in which said processing unit also triggers a reduction in flow if a difference in speed between the two phonic wheels is detected.

27. A calculation box, comprising:
a signal processing unit shaped to transmit, to the system for regulating a turbine engine equipped with an overspeed protection device as claimed in claim 15, a command to reduce the flow if it detects that the torque measured on an output shaft has dropped below a datum value.

28. A turbine engine, comprising:
a free turbine; and
an overspeed protection device for the free turbine as claimed in claim 15.
